(19) United States
(12) Patent Application Publication
(10) Pub. No.: US 2026/0236717 A1
(43) Pub. Date: Aug. 13, 2026

(54) MACHINE LEARNING MODEL WRAPPER FOR PREPROCESSING COMPLEX INSTRUCTIONS

(71) Applicant: NVIDIA Corporation, Santa Clara, CA (US)

(72) Inventors: Peter Belcak, Mountain View, CA (US); Pavlo Molchanov, Mountain View, CA (US)

(21) Appl. No.: 19/322,372

(22) Filed: Sep. 8, 2025

Related U.S. Application Data
(60) Provisional application No. 63/755,930, filed on Feb. 7, 2025.

(51) Int. Cl. G06F 40/40

(52) U.S. Cl. CPC G06F 40/40

(57) ABSTRACT

In machine learning, some models, such as language models, are trained to perform language processing tasks. These language processing tasks can include text generation, machine translation, sentiment analysis, question answering, content generation, code development, etc. However, these models are inherently unreliable, especially when prompted with complex (e.g. composite) instructions. For example, they are prone to miscarrying basic operations, ignoring explicitly stated formatting and behavioral constraints, and hallucinating new steps or step outcomes. The present disclosure provides a mechanism that preprocesses an instruction to a machine learning model to generate a sequence of instructions via which flow control and data control in the model may be enforced, thereby enhancing reliability of the output generated by the model.

### RELATED APPLICATION(S)

This application claims the benefit of U.S. Provisional Application No. 63/755,930 (Attorney Docket No. NVIDP1436+/25-SC-0170US01), titled “FRAME: A UNIVERSAL RELIABILITY HARNESS FOR INSTRUCTION EXECUTION” and filed Feb. 7, 2025, the entire contents of which is incorporated herein by reference.

### TECHNICAL FIELD

The present disclosure relates to instruction processing by machine learning models.

### BACKGROUND

In machine learning, some models, such as language models, are trained to perform language processing tasks. These language processing tasks can include text generation, machine translation, sentiment analysis, question answering, content generation, code development, etc. However, these models are inherently unreliable, especially when prompted with complex (e.g. composite) instructions. For example, they are prone to miscarrying basic operations, ignoring explicitly stated formatting and behavioral constraints, and hallucinating new steps or step outcomes.

There is thus a need for addressing these issues and/or other issues associated with the prior art. For example, there is a need to provide a mechanism that preprocesses an input prompt to a machine learning model to generate a sequence of instructions via which control flow and data flow in the model may be enforced, thereby enhancing reliability of the output generated by the model.

### SUMMARY

A method, computer readable medium, and system are disclosed to control instruction execution by a machine learning model. A prompt input by a user defining a task to be performed by a machine learning model is accessed. Automated preprocessing of the prompt is performed to generate a plurality of instructions executable by the machine learning model. A flow of execution of the plurality of instructions by the machine learning model is controlled, to generate an output for the prompt input by the user.

### BRIEF DESCRIPTION OF THE DRAWINGS

FIG. 1 illustrates a method for controlling instruction execution by a machine learning model, in accordance with an embodiment.

FIG. 2 illustrates a visualization of a machine learning model wrapped by a frame that provides instruction control for the machine learning model, in accordance with an embodiment.

FIG. 3 illustrates a method of the frame of FIG. 2, in accordance with an embodiment.

FIG. 4 illustrates an example of a complex instruction provided as a prompt to the machine learning model of FIG. 2, in accordance with an embodiment.

FIG. 5 illustrates an example of a complex instruction provided as a prompt to the machine learning model of FIG. 2, in accordance with an embodiment.

FIG. 6 illustrates an inference time method of the machine learning model of FIG. 3, in accordance with an embodiment.

FIG. 7A illustrates inference and/or training logic, according to at least one embodiment.

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

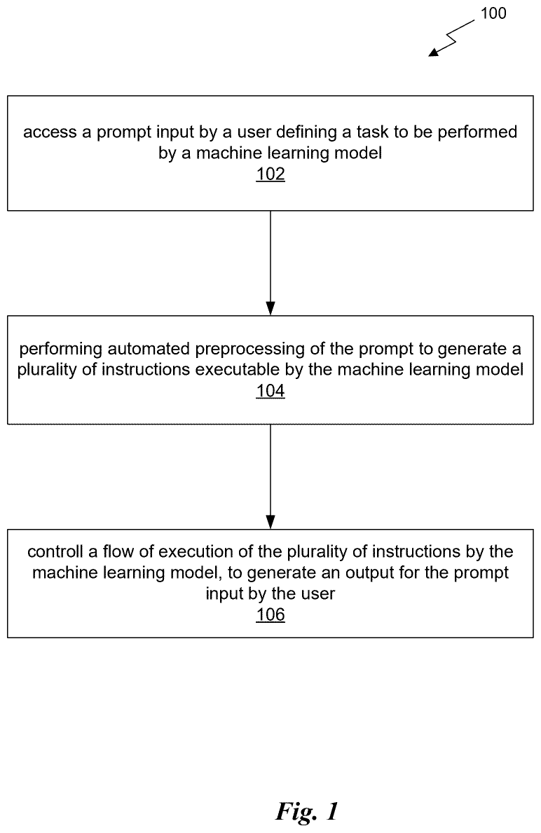

FIG. 1 illustrates a method 100 for controlling instruction execution by a machine learning model, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

With respect to the present embodiment, the machine learning model refers to a model trained via machine learning to perform at least one task based on an input prompt. In an embodiment, the machine learning model may be a language model, for example that is trained to perform one or more language processing tasks such as text generation, machine translation, sentiment analysis, question answering, content (e.g. report) generation, code development, etc. In another embodiment, the machine learning model may be a policy trained to provide motion planning or decision making for a robotic system.

In an embodiment, the method 100 may be performed by software that interfaces the machine learning model. In an embodiment, the software may be model agnostic, or in other words the software may interface any pretrained model configured to perform at least one task based on an input prompt. In an embodiment, the software may be implemented to frame, or as a wrapper to, the machine learning model. In an embodiment, the software may interface (e.g. provide input to and receive output from) the machine learning model via an application programming interface (API) of the machine learning model. In an embodiment, the method 100 may not require any customization of the machine learning model.

Returning to the method 100, in operation 102, a prompt input by a user defining a task to be performed by the machine learning model is accessed. The prompt that is input by the user refers to information that defines the task that the user wants to be performed by the machine learning model. In an embodiment, the prompt may be a text prompt. The text prompt may be provided in a natural language. In an embodiment, the prompt may include an image. In an embodiment, the prompt may include an example of an output to be generated by the machine learning model when the task is performed.

In an embodiment, the prompt may be a complex (e.g. composite) prompt. A complex prompt refers to a prompt that requires multiple instructions or steps to be performed by the machine learning model. In an embodiment, the complex prompt may expressly specify one or more of the instructions or steps. In an embodiment, the complex prompt may inherently require one or more of the instructions or steps.

In an embodiment, the prompt may be input by a human user via a chat interface of the machine learning model. In an embodiment, the prompt may be input by an application or process (acting as a user) via an application programming interface (API) of the machine learning model. In any case, the prompt may be accessed by the method 100 when it is input to the machine learning model by the user. For example, the method 100 may intercept the prompt when it is input to the machine learning model by the user, which may be achievable due to the software acting as a frame or wrapper to the machine learning model.

In operation 104, automated preprocessing of the prompt is performed to generate a plurality of instructions executable by the machine learning model. Thus, in an embodiment, the single input prompt, which may be a complex prompt as mentioned above, is preprocessed to generate a plurality of instructions executable by the machine learning model. In the present embodiment, the plurality of instructions are configured to accomplish the task defined by the input prompt. In an embodiment, the plurality of instructions may be defined in a sequence.

In an embodiment, the plurality of instructions may each be executable by the machine learning model for performing a sub-task of the task defined by the input prompt. For example, the input prompt may be a complex prompt and each of the plurality of instructions may be a simple, or non-complex, prompt. In an embodiment, each instruction of the plurality of instructions may include code. In an embodiment, each instruction of the plurality of instructions may include a relevant context of the instruction. For example, the relevant context may specify a state in which the instruction is to be performed. In an embodiment, the relevant context may be generated to be within a defined context window size.

In an embodiment, the automated preprocessing may be performed using a database of policies. In an embodiment, the automated preprocessing may be performed using library functions. In an embodiment, the automated preprocessing may be performed using another machine learning model, such has a language model.

In an embodiment, the automated preprocessing of the prompt may include: decomposing the prompt into a plurality of steps, and mirroring the plurality of steps into the plurality of instructions. In an embodiment, the decomposing may be performed using a language model. For example, the language model may reference a library of functions to decompose the prompt into the plurality of steps. In an embodiment, the automated preprocessing of the prompt may further include: decomposing the prompt into a general context, and compiling each step of the plurality of steps together with a relevant context determined from the general context to form a corresponding instruction of the plurality of instructions.

In operation 106, a flow of execution of the plurality of instructions by the machine learning model is controlled, to generate an output for the prompt input by the user. The flow of execution refers to the order in which the machine learning model processes input instructions. Controlling the flow of execution refers to causing the machine learning model to process instructions in a given order.

In an embodiment, controlling the flow of execution of the plurality of instructions by the machine learning model may include inputting the plurality of instructions to the machine learning model for processing in accordance with the sequence defined for the plurality of instructions. In an embodiment, controlling the flow of execution of the plurality of instructions by the machine learning model may further include re-inputting an instruction of the plurality of instructions to the machine learning model for a repeated execution thereof when a prior execution of the instruction by the machine learning model fails. In an embodiment, controlling the flow of execution of the plurality of instructions by the machine learning model may further include inputting a next instruction of the plurality of instructions to the machine learning model for execution thereof when execution of a prior instruction by the machine learning model succeeds.

Thus, controlling the flow of execution of the plurality of instructions by the machine learning model may involve monitoring a result of each instruction execution by the machine learning model and determining a next one of the instructions to be executed by the machine learning model based on the execution result. As it is determined that one of the instructions is to be executed by the machine learning model, that instruction may be input to the machine learning model for execution thereof. Once execution of the plurality of instructions by the machine learning model is complete, the resulting output may be provided by the machine learning model to the user as a response to the prompt input by the user.

To this end, the method 100, when performed, preprocesses an prompt input to a machine learning model to generate an executable sequence of instructions for the machine learning model. The method 100 improves the multi-step instruction following capability of the machine learning model, in an embodiment by strictly enforcing control flow and weakly enforcing data flow in the model. As described above, this is achieved in some embodiments by “mirroring” natural language instructions in the prompt into valid, executable fragments of code, and then managing execution of those code fragments by the model. In any case, this control flow can improve the reliability of the output generated by the machine learning model, particularly when compared with the reliability of any output generated by machine learning model directly from the input prompt.

Further embodiments will now be provided in the description of the subsequent figures. It should be noted that the embodiments disclosed herein with reference to the method 100 of FIG. 1 may apply to and/or be used in combination with any of the embodiments of the remaining figures below. As mentioned above, any descriptions herein that reference a LLM may equally apply to other types of machine learning models.

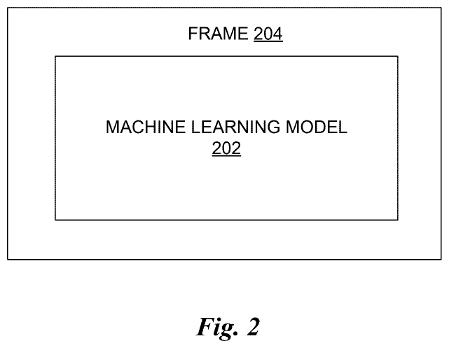

FIG. 2 illustrates a visualization of a machine learning model 202 wrapped by a frame 204 that provides instruction control for the machine learning model, in accordance with an embodiment. The frame 204 may be configured to perform the method 100 of FIG. 1, in an embodiment. Thus, the descriptions and definitions provided above may equally apply to the present embodiment.

The frame 204 is a software harness that wraps around the machine learning model 202 generation interface to enforce control flow (i.e. “which instruction goes next?”) and data flow (i.e. “what piece of context precisely should this instruction be performed on?”). The frame 204 is model-agnostic as it can be wrapped around any chat-capable machine learning model). The frame 204 is also seamlessly deployable since any existing code interfacing with the machine learning model 202 does not need to be modified in order to support the frame 204. When employed, the frame 204 enhances the reliability of the output of the machine learning model 202.

The frame 204 accesses a prompt input by a user to the machine learning model 202. The frame 204 performs automated preprocessing of the prompt to generate a plurality of instructions executable by the machine learning model 202. The frame 204 then controls a flow of execution of the plurality of instructions by the machine learning model 202, to generate an output for the prompt input by the user.

The frame 204 improves on the multi-step instruction following capability of the machine learning model 202 by strictly enforcing control flow and weakly enforcing data flow. This is achieved by the frame 204 converting the prompt into valid, executable instructions for the machine learning model 202 and then the frame 204 managing a flow of the execution of those instructions by the machine learning model 202.

In an embodiment, once the output for the prompt is generated and provided to the user, the prompt may be refined by the user to cause the machine learning model 202, under control of the frame 204 as described above, to generate a new output for the refined prompt. The prompt refinement may be employed to revise a quality of the instructions generated by the frame 204 to achieve the goal of the user.

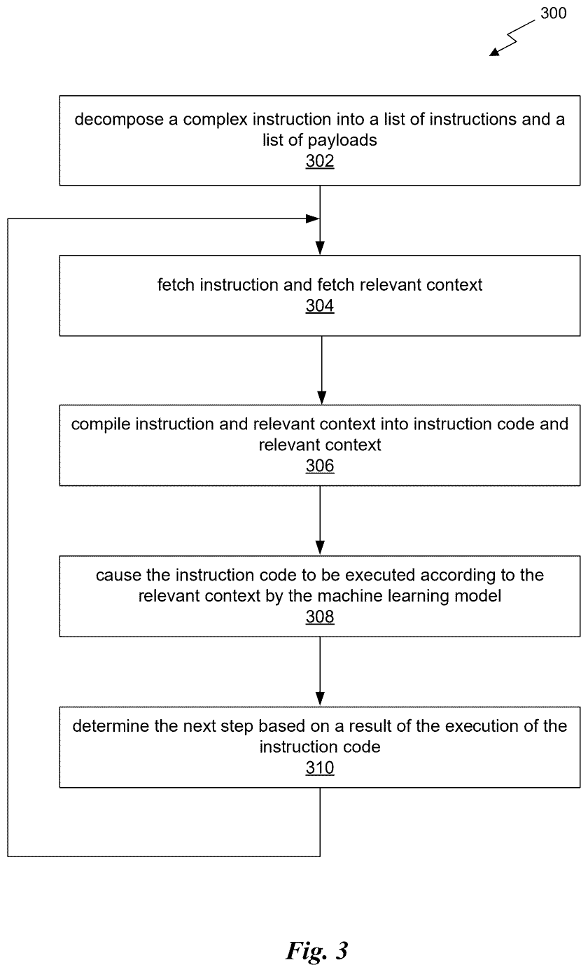

FIG. 3 illustrates a method 300 of the frame 204 of FIG. 2, in accordance with an embodiment. In operation 302, a complex instruction is decomposed into a list of instructions and a list of payloads. In the present embodiment, the complex instruction is received as a prompt to the machine learning model 202. In an embodiment, a language model other than the machine learning model 202 is used to decompose the complex instruction into the list of instructions and the list of payloads. The language model may reference a database of policies and/or library functions to decompose the complex instruction into the list of instructions and the list of payloads. The list of instructions may define a sequence in which the instructions are to be executed.

In operation 304, an instruction is fetched from the list of instructions and a relevant context is fetched for the instruction. The instruction may be fetched in accordance with a sequence defined for the list of instructions. For example, for an initial iteration of the method 300, a first instruction in the list of instructions may be fetched along with its relevant context. The relevant context is a context for an invocation of the machine learning model 202 that is relevant and essential to the instruction.

In operation 306, the instruction and the relevant context are compiled into instruction code and the relevant context. The instruction code is a deterministic piece of code that is executable by the machine learning model 202. In operation 308, the machine learning model 202 is caused to execute the instruction code according to the relevant context. For example, the instruction code may be input to the machine learning model 202 for execution thereof.

In operation 310, a next step to take is determined based on a result of the execution of the instruction code by the machine learning model 202. In an embodiment, the next step may include re-inputting the instruction code and the relevant context to the machine learning model 202 for a repeated execution thereof when the execution of the instruction code by the machine learning model 202 has failed. In another embodiment, when the instruction code is successfully executed by the machine learning model 202, then the next step may include returning to operation 304 to fetch a next instruction in the list of instructions. In this way, the method 300 may be performed to control an execution flow by the machine learning model 202.

To this end, the frame 204 operates to strongly enforce control flow by managing the step-wise execution of individual instruction steps by the model 202 deterministically rather than probabilistically through Chain-of-Thought (CoT). This guarantees that no steps will be skipped or omitted, and that action spillover will be minimized between steps. The frame 204 also operates to weakly enforce data flow by probabilistically retrieving relevant parts of inputs and outputs of previously executed steps and allowing the use of named memory through fuzzy/descriptive naming. This allows the model 202 to shrink its effective context on many tasks and improves its information extraction abilities. Further, the frame 204 does not interfere with model output generation on individual steps, which allows the frame 204 to inherit all the abilities of the original model 202.

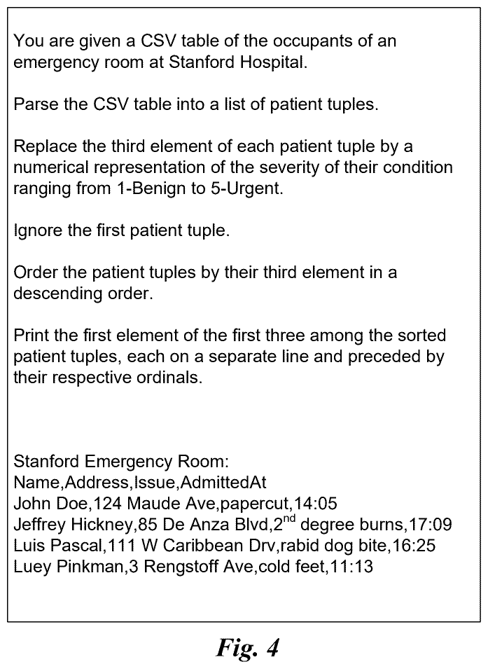

FIG. 4 illustrates an example of a complex instruction provided as a prompt to the machine learning model 202 of FIG. 2, in accordance with an embodiment. Despite its initial appearance as a simple, classical coding problem, this prompt requires both algorithmic accuracy (accurate sorting) and natural language understanding (assessing severity of patients' conditions) to be reliably executed. When processing the prompt using the frame 204 per the embodiments described above, the user feels no difference from interacting directly with the machine learning model 202. However, in the background the prompt is parsed by the frame 204 into general context, instruction steps, and payloads, and then the frame 204 follows a deterministic execution flow to find the output desired by the user.

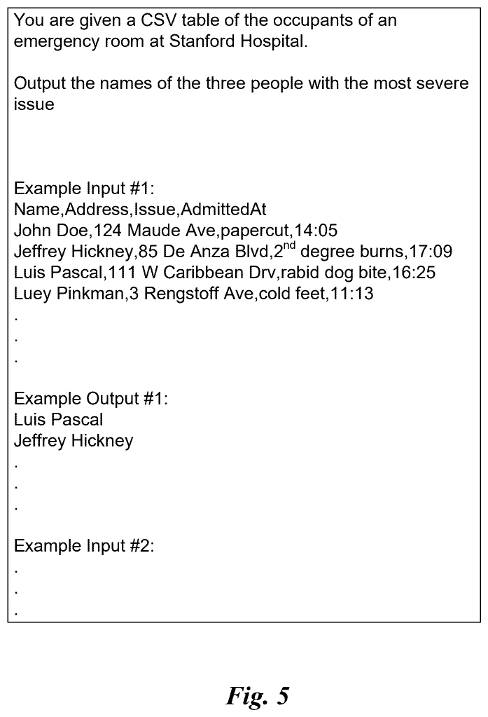

FIG. 5 illustrates an example of a complex instruction provided as a prompt to the machine learning model 202 of FIG. 2, in accordance with an embodiment. In an embodiment where a planner is used with the frame 204 to convert the prompt into a structured plan, the user does not need to provide the detailed instructions to be followed in the prompt, but it is expected that the user provides either one worked-through example or several input-output examples against which various decomposition beams can be tested.

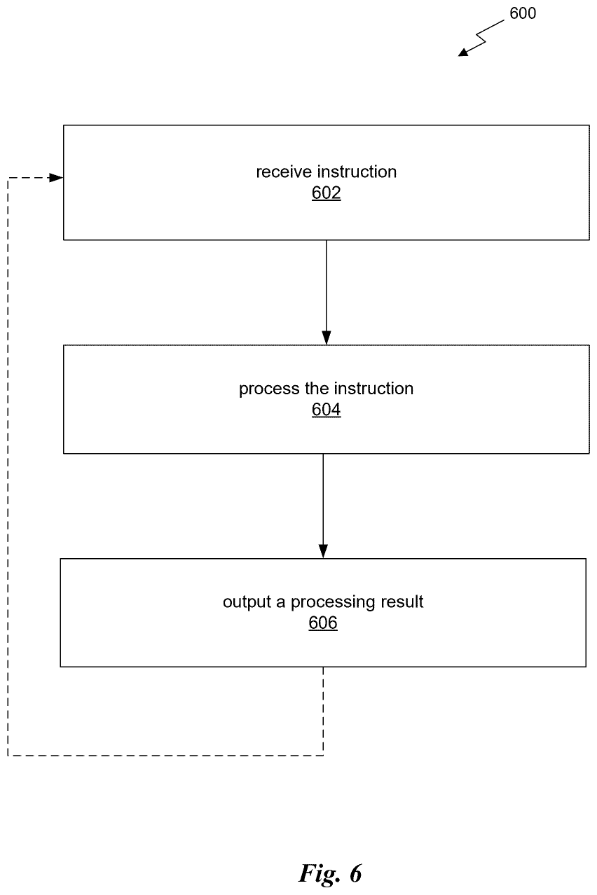

FIG. 6 illustrates an inference time method 600 of the machine learning model 202 of FIG. 3, in accordance with an embodiment. The method 600 is performed when a user inputs a prompt to the machine learning model 202.

In operation 602, an instruction is received. With respect to the present embodiment, the instruction is received from the frame 204. For an initial iteration of the method 600, the instruction may be an initial instruction in a sequence of instructions to be executed by the machine learning model 202.

In operation 604, the instruction is processed. A processing result is generated from the processing of the instruction. In an embodiment, the processing result may be an inference generated based on the instruction. In an embodiment, the processing result may be an error or other indicator that the instruction was not successfully executed.

In operation 606, the processing result is output. In an embodiment, the processing result may be an intermediate output that is returned to the frame 204 for use in determining a next step to be taken. In an embodiment, the processing result may be a final output (e.g. generated for a final instruction in the sequence of instructions) that is returned to the user as a response to the original input prompt. A type of the intermediate/final output may depend on the task that the particular machine learning model 202 is trained to perform. For example, the intermediate/final output may be a language-based output when the machine learning model 202 is trained to perform a language-based task. As another example, the intermediate/final output may be an action to be taken by a robotic system when the machine learning model 202 is a policy trained to provide motion planning or decision making for the robotic system.

### SUMMARY

The frame 204, as described herein, is a generalist, model-agnostic software that significantly boosts machine learning model 202 ability to follow complex instructions and perform repetitive tasks on behalf of a user.

The frame 204 lends Turing-completeness to the dialogue interface through which users interact with the machine learning model 202.

The frame 204 manages a collection of contexts yielding tractability of multi-step instructions and efficiency on long-context tasks.

Being biased toward the execution of sequences of simpler commands rather than singular composite instructions by design, the frame 204 implicitly lowers the requirement on the base model 202 predictive performance, thus indirectly further boosting the reliability and efficiency of the entire solution.

The frame 204 is a piece software that wraps around the machine learning model 202 in a way that the above embodiments are achieved while allowing the way in which the user interacts with it to remain unchanged. The machine learning model 202 does not need to be modified in order to support the frame 204, and accordingly the machine learning model 202 may remain unchanged when wrapped by the frame 204.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

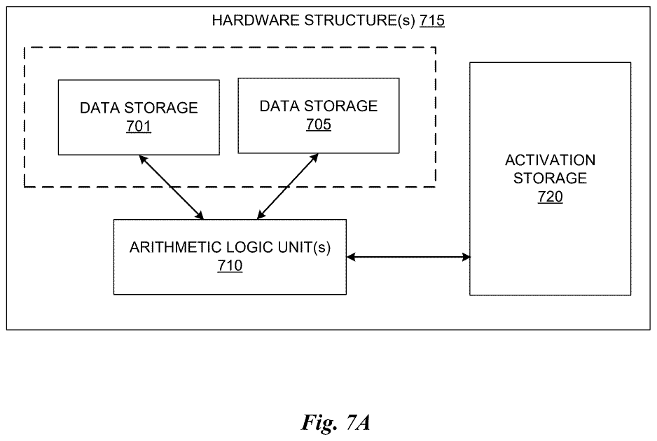

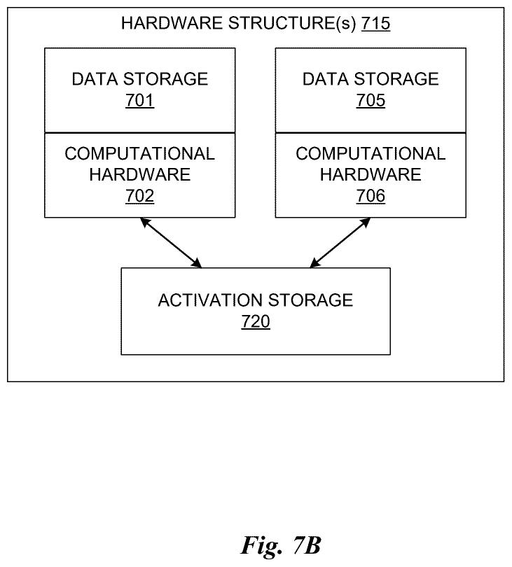

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

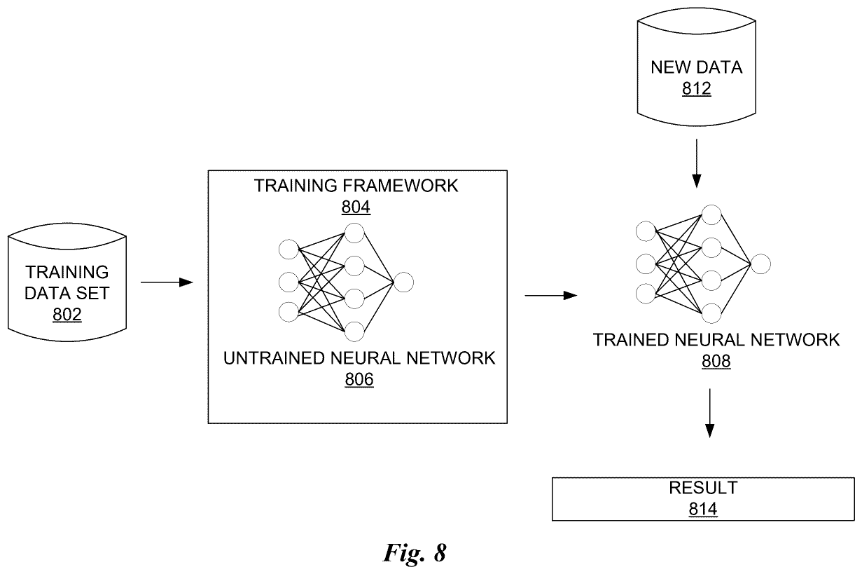

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

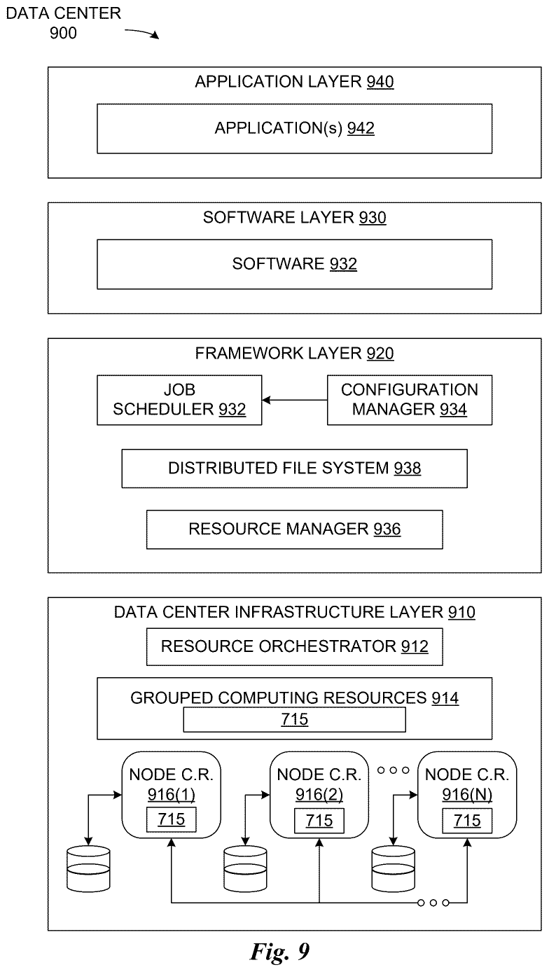

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R. s”) 916(1)-916(N), where “N” represents any whole, positive integer. In at least one embodiment, node C.R. s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for controlling instruction execution by a machine learning model. In accordance with FIGS. 1-6, embodiments may provide such a model, wrapped by a software frame, for performing inferencing operations and for providing inferenced data. The model and frame may be stored (partially or wholly) in one or both of data storage 701 and 705 in inference and/or training logic 715 as depicted in FIGS. 7A and 7B. Training and deployment of the model may be performed as depicted in FIG. 8 and described herein. Distribution of the model and frame may be performed using one or more servers in a data center 900 as depicted in FIG. 9 and described herein.

What is claimed is:

1. A method, comprising:
at a device:
accessing a prompt input by a user defining a task to be performed by a machine learning model;
performing automated preprocessing of the prompt to generate a plurality of instructions executable by the machine learning model; and
controlling a flow of execution of the plurality of instructions by the machine learning model, to generate an output for the prompt input by the user.

2. The method of claim 1, wherein the machine learning model is a language model.

3. The method of claim 1, wherein the prompt is a text prompt.

4. The method of claim 1, wherein the prompt is input by the user via a chat interface of the machine learning model.

5. The method of claim 1, wherein the method is performed by model agonistic software that interfaces the machine learning model.

6. The method of claim 1, wherein each instruction of the plurality of instructions includes code.

7. The method of claim 1, wherein each instruction of the plurality of instructions includes a relevant context of the instruction.

8. The method of claim 7, wherein the relevant context is generated to be within a defined context window size.

9. The method of claim 1, wherein the automated preprocessing of the prompt includes:
decomposing the prompt into a plurality of steps, and
mirroring the plurality of steps into the plurality of instructions.

10. The method of claim 9, wherein the decomposing is performed using a language model.

11. The method of claim 10, wherein the language model references a library of functions to decompose the prompt into the plurality of steps.

12. The method of claim 9, wherein the automated preprocessing of the prompt further includes:
decomposing the prompt into a general context, and
compiling each step of the plurality of steps together with a relevant context determined from the general context to form a corresponding instruction of the plurality of instructions.

13. The method of claim 1, wherein the plurality of instructions are defined in a sequence.

14. The method of claim 13, wherein controlling the flow of execution of the plurality of instructions by the machine learning model includes inputting the plurality of instructions to the machine learning model for processing in accordance with the sequence.

15. The method of claim 14, wherein controlling the flow of execution of the plurality of instructions by the machine learning model further includes re-inputting an instruction of the plurality of instructions to the machine learning model for a repeated execution thereof when a prior execution of the instruction by the machine learning model fails.

16. The method of claim 14, wherein controlling the flow of execution of the plurality of instructions by the machine learning model further includes inputting a next instruction of the plurality of instructions to the machine learning model for execution thereof when execution of a prior instruction by the machine learning model succeeds.

17. The method of claim 1, wherein the machine learning model provides the output to the user.

18. A system, comprising:
a non-transitory memory storage comprising instructions; and
one or more processors in communication with the memory, wherein the one or more processors execute the instructions to:
access a prompt input by a user defining a task to be performed by a machine learning model;
perform automated preprocessing of the prompt to generate a plurality of instructions executable by the machine learning model; and
control a flow of execution of the plurality of instructions by the machine learning model, to generate an output for the prompt input by the user.

19. The system of claim 18, wherein each instruction of the plurality of instructions includes code.

20. The system of claim 18, wherein each instruction of the plurality of instructions includes a relevant context of the instruction.

21. The system of claim 18, wherein the automated preprocessing of the prompt includes:
decomposing the prompt into a plurality of steps, and
mirroring the plurality of steps into the plurality of instructions.

22. The system of claim 21, wherein the automated preprocessing of the prompt further includes:
decomposing the prompt into a general context, and
compiling each step of the plurality of steps together with a relevant context determined from the general context to form a corresponding instruction of the plurality of instructions.

23. The system of claim 18, wherein the plurality of instructions are defined in a sequence.

24. The system of claim 23, wherein controlling the flow of execution of the plurality of instructions by the machine learning model includes inputting the plurality of instructions to the machine learning model for processing in accordance with the sequence.

25. The system of claim 18, wherein the machine learning model provides the output to the user.

26. A non-transitory computer-readable media storing computer instructions which when executed by one or more processors of a device cause the device to:
access a prompt input by a user defining a task to be performed by a machine learning model;
perform automated preprocessing of the prompt to generate a plurality of instructions executable by the machine learning model; and
control a flow of execution of the plurality of instructions by the machine learning model, to generate an output for the prompt input by the user.

27. The non-transitory computer-readable media of claim 26, wherein each instruction of the plurality of instructions includes code.

28. The non-transitory computer-readable media of claim 26, wherein each instruction of the plurality of instructions includes a relevant context of the instruction.

29. The non-transitory computer-readable media of claim 26, wherein the automated preprocessing of the prompt includes:
decomposing the prompt into a plurality of steps, and
mirroring the plurality of steps into the plurality of instructions.

30. The non-transitory computer-readable media of claim 29, wherein the automated preprocessing of the prompt further includes:
decomposing the prompt into a general context, and
compiling each step of the plurality of steps together with a relevant context determined from the general context to form a corresponding instruction of the plurality of instructions.

31. The non-transitory computer-readable media of claim 26, wherein the plurality of instructions are defined in a sequence.

32. The non-transitory computer-readable media of claim 31, wherein controlling the flow of execution of the plurality of instructions by the machine learning model includes inputting the plurality of instructions to the machine learning model for processing in accordance with the sequence.

33. The non-transitory computer-readable media of claim 26, wherein the machine learning model provides the output to the user.
